(19) United States
(12) Patent Application Publication
(10) Pub. No.: US 2025/0097506 A1
(43) Pub. Date: Mar. 20, 2025

(54) MULTI-VIEW RESOURCE ALLOCATION METHOD AND APPARATUS

(71) Applicant: SAMSUNG ELECTRONICS CO., LTD., Suwon-si (KR)

(72) Inventors: Xianghu CHEN, Jiangsu (CN); Yong Zhang, Jiangsu (CN); Zuolong Wang, Jiangsu (CN)

(73) Assignee: SAMSUNG ELECTRONICS CO., LTD., Suwon-si (KR)

(21) Appl. No.: 18/959,030

(22) Filed: Nov. 25, 2024

Related U.S. Application Data
(63) Continuation of application No. PCT/KR2023/007054, filed on May 24, 2023.

(30) Foreign Application Priority Data
May 25, 2022 (CN) 202210578334.1

(51) Int. Cl. H04N 21/422; H04N 21/41

(52) U.S. Cl. CPC H04N 21/42204; H04N 21/4126

(57) ABSTRACT

A multi-view resource allocation method includes based on determining that an application (APP) of a terminal device is started, determining, by the terminal device, a resource type allocated for the APP on the basis of a current view mode that is a single-view mode or a multi-view mode, and the resource type being a main resource or a sub-resource; and acquiring, by the APP, a corresponding resource according to the allocated resource type.

### CROSS-REFERENCE TO RELATED APPLICATIONS

This application is a continuation of PCT International Application No. PCT/KR2023/007054, which was filed on May 24, 2023, and claims priority to Chinese Patent Application No. 202210578334.1, filed on May 25, 2022, the disclosures of each of which are incorporated by reference herein their entirety.

### BACKGROUND

### 1. Field

The disclosure relates to a multimedia playing technology, and in particular, to a multi-view resource allocation method and apparatus.

### 2. Description of Related Art

With the development of smart televisions, multi-view has gradually become a function well received by consumers. Multi-view may simultaneously display multiple sources on a multimedia playing terminal device (such as a smart television platform), and users are allowed to enjoy various television-related functions more conveniently and richly on a large screen (as shown in FIG. 1).

For multi-view, a multimedia playing terminal device will be configured with different types of resources, such as main resources or sub-resources. For example, if a smart television platform supports up to two views, the smart television platform has a main resource and a sub-resource. The main resource may decode an ultra high definition (UHD) (a resolution of 3840×2160, commonly referred to as 4K, or a resolution of 7680×4320, commonly referred to as 8K). The sub-resource may only decode a full high definition (FHD) (a resolution of 1920*1080, commonly referred to as 2K).

Accordingly, the multimedia playing terminal device will divide a display region into different sub-regions, and configure a fixed type of resource for each sub-region. As shown in FIG. 2, a multimedia playing terminal device will adopt a mode of situation 1 in the figure, a main resource is fixedly used on the left side, and a sub-resource is fixedly used on the right side. Alternatively, a multimedia playing terminal device will adopt a mode of situation 2 in the figure, a sub-resource is fixedly used on the left side, and a main resource is fixedly used on the right side.

During implementation of the disclosure, the inventors have found that existing schemes of allocating resources for a multimedia application (APP) are prone to resource allocation conflicts. The specific reasons are analyzed as follows:

In the existing schemes, when a multimedia APP is started, the multimedia APP applies for a corresponding type of resources from a multimedia playing terminal device according to a pre-configured resource type. In this resource allocation method, a current resource allocation condition of the multimedia playing terminal device is not considered when the multimedia APP applies for resources. Thus, if resources applied for by a currently started multimedia APP have been allocated to other multimedia APPs, the resource allocation will conflict, and then APPs which have occupied the same resource will cause screen blackout since the resources are occupied. For example, as shown in FIG. 3, in a single-view mode, APP1 occupies a main resource. At this moment, if APP2 is started, since APP2 does not know that it is currently in a multi-view mode and still applies for the main resource, the main resource already occupied by APP1 may be preempted, whereby APP1 enters a screen blackout state since the main resource is preempted.

In addition, since APPs are required to autonomously determine resources to be used according to the existing schemes, the types of resources available for APPs under different scenarios are different in order to meet execution requirements of each APP executed in a practical application scenario in practical applications. For example, all resources of a device may be used in a single-view mode, and a main resource or a sub-resource may be used in a multi-view mode. In this way, when an APP developer develops an APP, a resource type used by the APP cannot be accurately set, whereby the APP may apply for a resource matching an actual application scenario thereof, thus resulting in poor expansibility and flexibility of a multi-view function.

### SUMMARY

In view of this, a main object of the disclosure is to provide a multi-view resource allocation method and apparatus, which can effectively solve the problem of resource allocation conflicts in a multi-view scenario.

In order to achieve the aforementioned object, embodiments of the disclosure provide the following technical solution.

According to an aspect of the disclosure, a multi-view resource allocation method comprises: based on determining that an application (APP) of a terminal device is started, determining, by the terminal device, a resource type allocated for the APP based on a current view mode that is a single-view mode or a multi-view mode, and the resource type being a main resource or a sub-resource; and acquiring, by the APP, a corresponding resource according to the resource type allocated for the APP.

According to an aspect of the disclosure, the determining the resource type allocated for the APP comprises: based on determining that the view mode is the single-view mode, determining a resource type allocated for the APP based on a preset resource type of the APP; and based on determining that the view mode is the multi-view mode, querying a preset mapping relationship between display sub-regions and resource types based on a display sub-region used by the APP in the multi-view mode, obtaining a resource type corresponding to the display sub-region, and allocating the resource type to the APP, wherein the display sub-region is obtained (i) according to a preset multi-view display region allocation strategy and (ii) based on an occupation condition of a display region upon the APP being started.

According to an aspect of the disclosure, the method further comprises: based on determining that the terminal device is required to switch from the single-view mode to the multi-view mode and a determination that a first App in focus in the single-view mode is still executed in the multi-view mode, triggering, by the terminal device, the first App to release a sub-resource occupied thereby; determining a resource type corresponding to a display sub-region used by the first APP in the multi-view mode according to a preset mapping relationship between display sub-regions and resource types; based on determining that the first APP corresponds to different resource types before and after the switching, triggering the first APP to release a main resource occupied thereby and acquiring a corresponding resource based on the resource type corresponding to the display sub-region, wherein the display sub-region is obtained according to a preset multi-view display region allocation strategy and based on an occupation condition of a display region upon the first APP being started; and based on determining that a maximum resolution supported by the resource type corresponding to the first App in the multi-view mode is less than a maximum resolution supported by a resource type corresponding to the first App in the single-view mode, triggering the first APP to update an allowable maximum resolution thereof to the maximum resolution supported by the resource type corresponding thereto in the multi-view mode, and adjusting and controlling a playing content in the multi-view mode based on the allowable maximum resolution.

According to an aspect of the disclosure, the adjusting and controlling a playing content in the multi-view mode comprises: determining, by a first APP, whether a resolution of a current playing content exceeds an allowable maximum resolution; and based on determining that that the current playing content exceeds the allowable maximum resolution, adjusting the current playing content to a playing content with a first resolution or notifying a user that the resolution of the current playing content is not supported, the first resolution being less than or equal to the allowable maximum resolution.

According to an aspect of the disclosure, the method further comprises: determining that the terminal device switches from the multi-view mode to the single-view mode and based on determining that a second APP in focus after the switching uses a sub-resource in the multi-view mode, triggering the second APP to release the sub-resource and to acquire a main resource in the single-view mode; triggering the second APP to update a currently allowable maximum resolution to a maximum resolution supported based on determining that the main resource is used in the single-view mode; and adjusting and controlling, by the second APP, a playing content in the single-view mode based on an allowable maximum resolution.

According to an aspect of the disclosure, the adjusting and controlling a playing content in the single-view mode comprises: determining, by a second APP, whether a resolution of a current playing content is less than an allowable maximum resolution; and based on determining that the resolution of the current playing content is less than the allowable maximum resolution, adjusting the current playing content to a playing content with a second resolution or notifying a user that a playing content with a higher resolution is currently supported, the second resolution being greater than the resolution of the current playing content and less than or equal to the allowable maximum resolution.

According to an aspect of the disclosure, the method further comprises: receiving, by the terminal device, an APP starting instruction from a user via a multi-view APP in the single-view mode, starting a corresponding APP according to the APP starting instruction, and entering the multi-view mode, wherein a user interface of the multi-view APP provides, for each display sub-region, an APP set capable of currently using the display sub-region, whereby the user selects to start using the APP of the display sub-region based on the APP set, and the APP set is obtained (i) according to a preset multi-view display region allocation strategy and (ii) based on an occupation condition of a current display region and an installed APP in the terminal device.

According to an aspect of the disclosure, a computing device, comprises: a memory storing a program for allocating multi-view resources; and at least one processor, wherein the at least one processor is configured to execute the program to: enable, based on determining that an application (APP) of a terminal device is started, the terminal device to determine a resource type allocated for the APP based on a current view mode that is a single-view mode or a multi-view mode, and the resource type being a main resource or a sub-resource, and acquire, by the APP, a corresponding resource according to the resource type allocated for the APP.

According to an aspect of the disclosure, wherein, while enabling the terminal device to determine the resource type allocated for the APP, the at least one processor is further configured to: based on determining that the view mode is the single-view mode, enable the terminal device to determine the resource type allocated for the APP based on a preset resource type of the APP, and based on determining that the view mode is the multi-view mode, enable the terminal device to query a preset mapping relationship between display sub-regions and resource types based on a display sub-region used by the APP in the multi-view mode, obtain a resource type corresponding to the display sub-region, and allocate the resource type to the APP, wherein the display sub-region is obtained (i) according to a preset multi-view display region allocation strategy and (ii) based on an occupation condition of a display region when the APP is started.

According to an aspect of the disclosure, the at least one processor is further configured to: based on determining that the terminal device is required to switch from the single-view mode to the multi-view mode and based on determining that a first App in focus in the single-view mode is still executed in the multi-view mode, enable the terminal device to trigger the first App to release a sub-resource occupied thereby, determine a resource type corresponding to a display sub-region used by the first APP in the multi-view mode according to a preset mapping relationship between display sub-regions and resource types, based on determining that the first APP corresponds to different resource types before and after the switching, trigger the first APP to release a main resource occupied thereby and acquire a corresponding resource based on the resource type corresponding to the display sub-region, wherein the display sub-region is obtained according to a preset multi-view display region allocation strategy and based on an occupation condition of a display region upon the first APP being started, and based on determining that a maximum resolution supported by the resource type corresponding to the first App in the multi-view mode is less than a maximum resolution supported by a resource type corresponding to the first App in the single-view mode, trigger the first APP to update an allowable maximum resolution thereof to the maximum resolution supported by the resource type corresponding thereto in the multi-view mode, and adjust and control a playing content in the multi-view mode based on the allowable maximum resolution.

According to an aspect of the disclosure, wherein, while adjusting and controlling a playing content in the multi-view mode, the at least one processor is further configured to: determine, by a first APP, whether a resolution of a current playing content exceeds an allowable maximum resolution, and based on determining that the current playing content exceeds the allowable maximum resolution, adjust the current playing content to a playing content with a first resolution or notify a user that the resolution of the current playing content is not supported, the first resolution being less than or equal to the allowable maximum resolution.

According to an aspect of the disclosure, the at least one processor is further configured to: based on determining that the terminal device switches from the multi-view mode to the single-view mode and based on determining that a second APP in focus after the switching uses a sub-resource in the multi-view mode, trigger the second APP to release the sub-resource and to acquire a main resource in the single-view mode; trigger the second APP to update a currently allowable maximum resolution to a maximum resolution supported based on determining that the main resource is used in the single-view mode; and adjust and control, by the second APP, a playing content in the single-view mode based on an allowable maximum resolution.

According to an aspect of the disclosure, wherein, while adjusting and controlling a playing content in the single-view mode, the at least one processor is further configured to: determine, by a second APP, whether a resolution of a current playing content is less than an allowable maximum resolution, and based on determining that the resolution of the current playing content is less than the allowable maximum resolution, adjust the current playing content to a playing content with a second resolution or notify a user that a playing content with a higher resolution is currently supported, the second resolution being greater than the resolution of the current playing content and less than or equal to the allowable maximum resolution.

According to an aspect of the disclosure, the at least one processor is further configured to: enable the terminal device to receive an APP starting instruction from a user via a multi-view APP in the single-view mode, start a corresponding APP according to the APP starting instruction, and enter the multi-view mode, wherein a user interface of the multi-view APP provides, for each display sub-region, an APP set capable of currently using the display sub-region, whereby the user selects to start using the APP of the display sub-region based on the APP set, and the APP set is obtained (i) according to a preset multi-view display region allocation strategy and (ii) based on an occupation condition of a current display region and an installed APP in the terminal device.

According to an aspect of the disclosure, a non-transitory computer readable medium having instructions stored therein, which when executed by a processor cause the processor to execute a method for performing multi-view resource allocation, the method comprising: based on determining that an application (APP) of a terminal device is started, determining, by the terminal device, a resource type allocated for the APP based on a current view mode that is a single-view mode or a multi-view mode, and the resource type being a main resource or a sub-resource; and acquiring, by the APP, a corresponding resource according to the resource type allocated for the APP.

In summary, according to a multi-view resource allocation scheme provided by the embodiments of the disclosure, when a multimedia APP is started, a terminal device determines the type of resources which may be applied for by the multimedia APP on the basis of a current view mode, i.e. a single-view mode or a multi-view mode. In this way, the resources allocated for the multimedia APP may be matched with an actual application scenario, thereby avoiding the problem of resource allocation conflicts in a multi-view scenario.

### BRIEF DESCRIPTION OF DRAWINGS

FIG. 1 is a schematic diagram of multi-view;

FIG. 2 is a schematic diagram of binding of different types of resources to display sub-regions in a multi-view mode;

FIG. 3 is a schematic diagram of resource allocation conflicts in existing schemes;

FIG. 4 is a flowchart of a method according to one or more embodiments of the disclosure;

FIG. 5 is an example diagram of a multi-view scenario to which a multi-view display region allocation strategy is applicable;

FIG. 6 is an example diagram of a mapping relationship between display sub-regions and resource types according to one or more embodiments of the disclosure;

FIG. 7 is an example diagram of allocation of a display sub-region for an APP in a multi-view mode according to one or more embodiments of the disclosure;

FIG. 8 is a schematic diagram of a first example of determining a resource type for an APP according to a mapping relationship between display sub-regions and resource types and on the basis of an APP display sub-region in a multi-view mode;

FIG. 9 is a schematic diagram of a second example of determining a resource type for an APP according to a mapping relationship between display sub-regions and resource types and on the basis of an APP display sub-region in a multi-view mode;

FIG. 10 is a flowchart of an example of allocating resources for an APP in a single-view mode according to one or more embodiments of the disclosure;

FIG. 11 is a flowchart of an example of allocating resources for an APP in a multi-view mode according to one or more embodiments of the disclosure;

FIG. 12 is an example diagram of entering a multi-view mode according to one or more embodiments of the disclosure;

FIG. 13 is an example diagram of a process in which resources are not required to be re-allocated for an APP in a single-view mode when entering a multi-view mode according to one or more embodiments of the disclosure;

FIG. 14 is an example diagram of a process in which resources are required to be re-allocated for an APP in a single-view mode when entering a multi-view mode according to one or more embodiments of the disclosure;

FIG. 15 is an example diagram of switching from a multi-view mode to a single-view mode according to one or more embodiments of the disclosure;

FIG. 16 is a schematic diagram of a first specific implementation example process including operations b1-b3 in one or more embodiments of the disclosure;

FIG. 17 is a schematic diagram of a second specific implementation example process including operations b1-b3 in one or more embodiments of the disclosure;

FIGS. 18-22 are schematic diagrams of implementation example processes in different application scenarios according to one or more embodiments of the disclosure; and

FIG. 23 is a structural schematic diagram of an apparatus according to one or more embodiments of the disclosure.

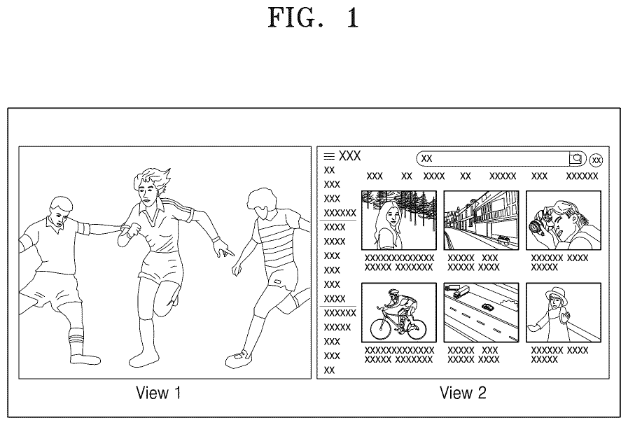

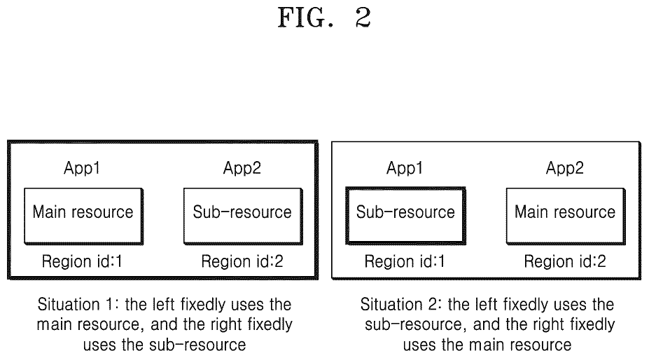

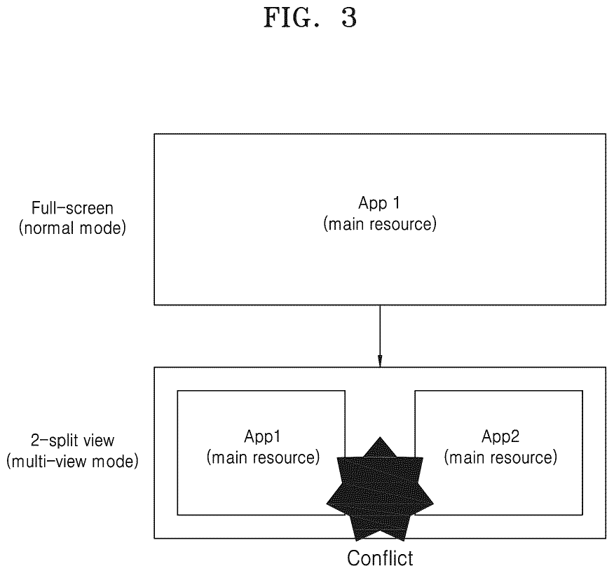

### DETAILED DESCRIPTION

In order to more clarify the objects, technical solutions and advantages of the disclosure, the disclosure will be further described in detail below with reference to the accompanying drawings and specific embodiments.

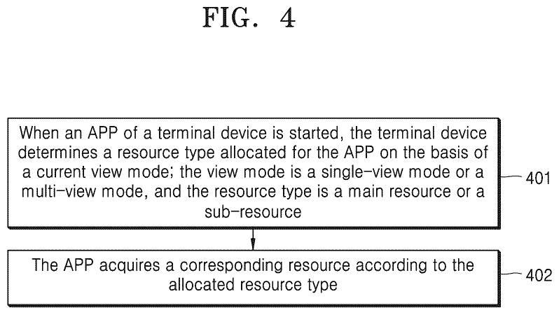

FIG. 4 is a flowchart of a multi-view resource allocation method according to one or more embodiments of the disclosure. As shown in FIG. 4, the embodiment mainly includes the following operations.

In operation 401, when an APP of a terminal device is started, the terminal device determines a resource type allocated for the APP on the basis of a current view mode. The view mode is a single-view mode or a multi-view mode, and the resource type is a main resource or a sub-resource.

In this operation, in order to avoid the problem of resource allocation conflicts, an APP no longer determines a resource to be applied for, but a terminal device distinguishes between a single-view mode and a multi-view mode instead, and determines a resource which may be applied for an APP required to be executed currently. In this way, the resource allocated for the APP may be matched with a current view scenario, thereby avoiding the problem of resource conflicts.

In practical applications, the terminal device is a multimedia playing terminal device, for example but not limited to, a smart television.

In an implementation, preferably, in order to more accurately ensure that the problem of resource conflicts is avoided, the resource type allocated for the APP may be determined on the basis of a current view mode by using the following method.

If the view mode is a single-view mode, a resource type allocated for the APP is determined on the basis of a preset resource type of the APP.

If the view mode is a multi-view mode, a preset mapping relationship between display sub-regions and resource types is queried on the basis of a display sub-region used by the APP in the multi-view mode, a resource type corresponding to the display sub-region is obtained, and the obtained resource type is allocated to the APP. The display sub-region is obtained according to a preset multi-view display region allocation strategy and on the basis of an occupation condition of a display region when the APP is started.

In the aforementioned method, if it is currently in a single-view mode, a preset resource type of a multimedia APP is directly used as a resource type allocated for the multimedia APP. Specifically, the preset resource type of the multimedia APP may be set by a person skilled in the art according to actual execution requirements of the APP. The descriptions thereof are omitted herein. If it is currently in a multi-view mode, a preset mapping relationship between display sub-regions and resource types is required to be queried on the basis of a display sub-region used by the multimedia APP in the multi-view mode, a resource type corresponding to the display sub-region is obtained, and the obtained resource type is allocated to the multimedia APP. Moreover, the display sub-region used by the multimedia APP in the multi-view mode will be obtained according to a preset multi-view display region allocation strategy and on the basis of an occupation condition of a display region of the terminal device when the APP is started. In this way, it may be ensured that the resource allocated for the multimedia APP may meet execution requirements thereof and also avoid allocating the same resource for different APPs.

In practical applications, a person skilled in the art would have been able to set the multi-view display region allocation strategy by considering the features of different APPs and the resource configuration of the terminal device according to practical application requirements. For example, it is possible to set tables, not limited to, the following Table 1:

TABLE 1

| Specifi- | | | |
|---|---|---|---|
| cation | | | |
| category | Specification | App feature | Remarks |
| Source | 1.1 A | Only limited to | Default |
| | broadcast/broadband | FHD, basic | rule |
| | channel-class App is on | functions of | |
| | the left | television | |
| | 1.2 Mobile phone | Remote devices | Default |
| | mirror/screen | are connected to | rule |
| | projection, AirPlay | start multi-view | |
| | (UHD) App on the right | | |
| Order | 2.1 An existing App is | In the order of | Default |
| | on the left and an App | adding into | rule |
| | newly added into multi- | multi-view | |
| | view is on the right | | |
| User preset | 3.1 Users decide which | Users may define | User |
| | App is on the left and | and save favorite | decision |
| | which App is on the | layouts | |
| | right according to habits | | |
| | or preferences | | |
| Platform | 4.1 Functional | Appx (e.g. AirPlay) | Platform |
| | differences due to | isnot supported on | decision |
| | platform resource | platform A but | |
| | limitations | supported on | |
| | | platform B | |

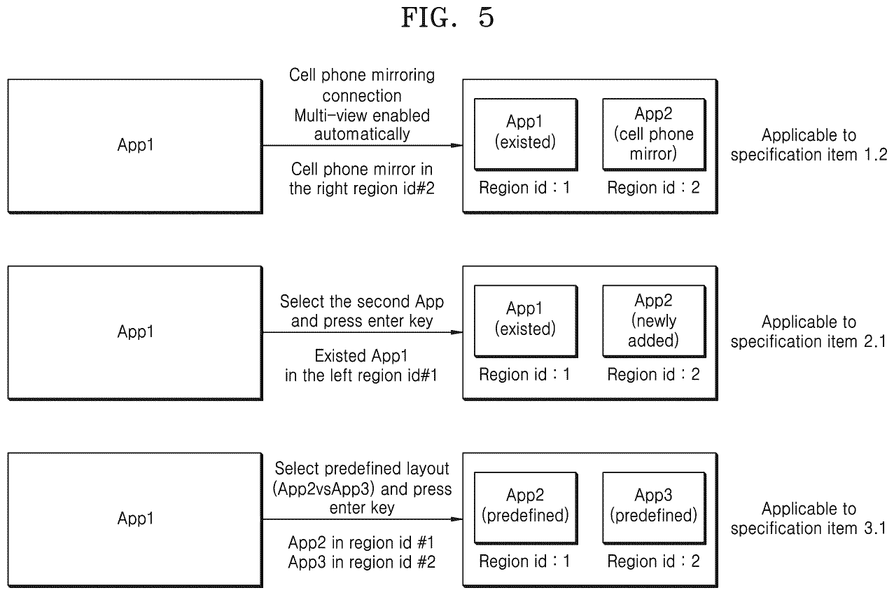

The specifications in the aforementioned table are specific rules included in the multi-view display region allocation strategy. Each rule may correspond to different multi-view application scenarios. As shown in FIG. 5, examples of application scenarios to which the aforementioned specifications 1.2, 2.1, and 3.1 are respectively adapted are given. In practical applications, the priority of each rule may be set as required.

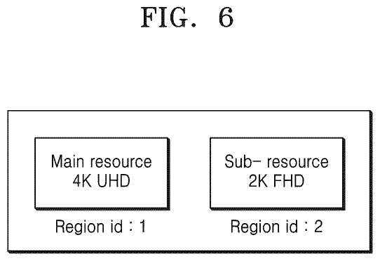

In practical applications, a mapping relationship between display sub-regions and resource types may be set by a person skilled in the art according to actual requirements. For example, the terminal device adopts the mapping relationship between the display sub-regions and the resource types as shown in FIG. 6.

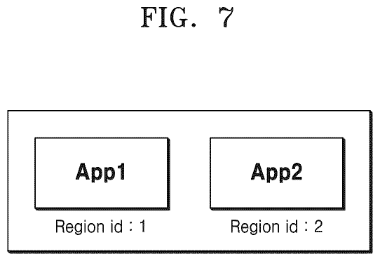

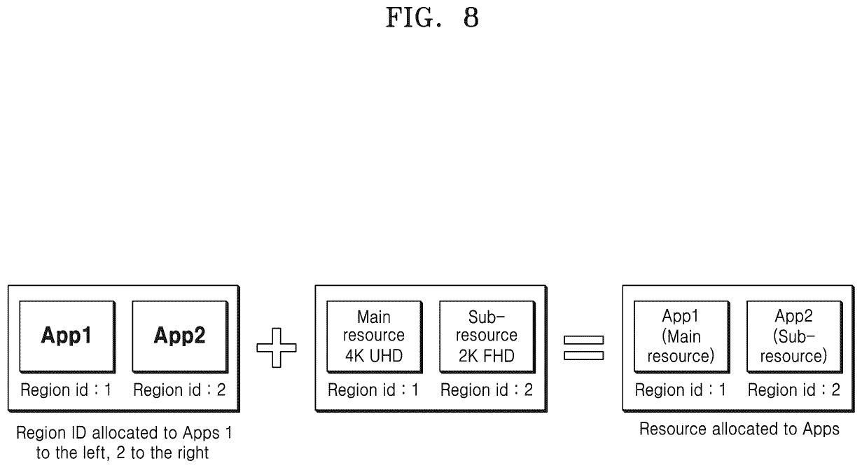

It is assumed that the terminal device adopts the mapping relationship between the display sub-regions and the resource types as shown in FIG. 6, a main resource is located on the left, a sub-resource is located on the right, and display sub-regions allocated to APP1 and APP2 in a multi-view mode are respectively region 1 and region 2 (as shown in FIG. 7). Then resource types allocated thereto are respectively the main resource and the sub-resource as shown in the right side of FIG. 8.

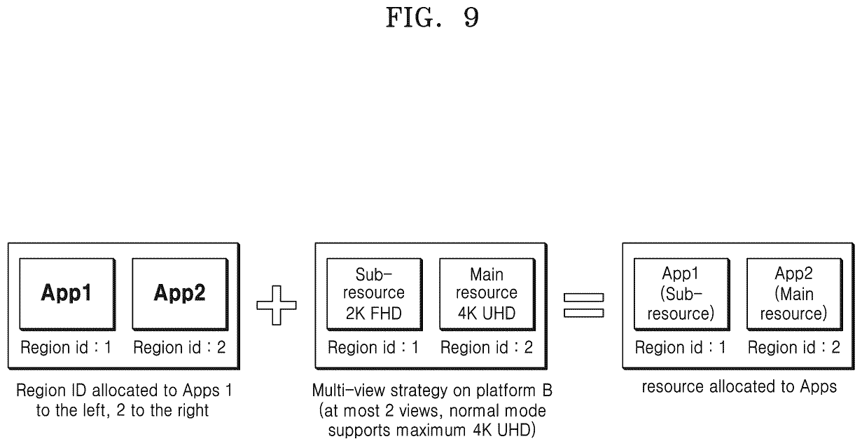

It is assumed that the terminal device adopts the mapping relationship between the display sub-regions and the resource types, where a sub-resource is located on the left, a main resource is located on the right, and display sub-regions allocated to APP1 and APP2 in a multi-view mode are respectively region 1 and region 2. Then resource types allocated thereto are respectively the sub-resource and the main resource as shown in the right side of FIG. 9.

In operation 402, the APP acquires a corresponding resource according to the allocated resource type.

Here, since the APP acquires a resource used thereby for execution according to the resource type decided by the terminal device on the basis of the current view mode, preempting other APP resources may be effectively avoided.

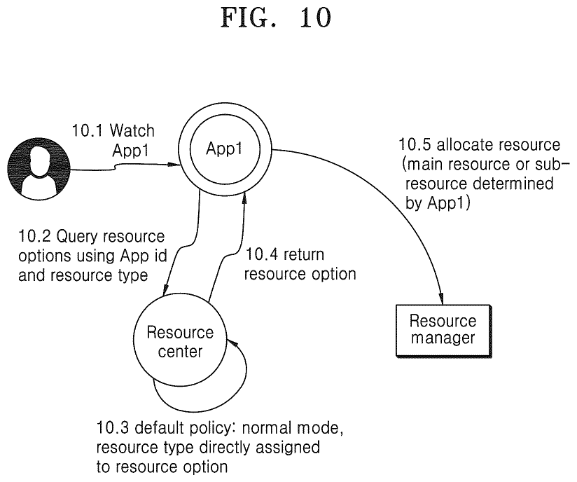

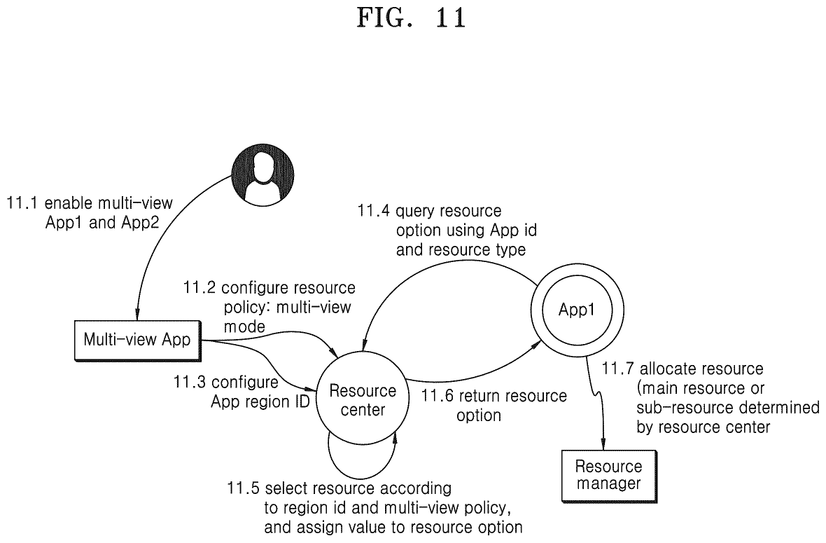

The allocation of resources for an APP in the single-view mode and the multi-view mode on the basis of operations 401-402 will now be exemplified with reference to FIGS. 10 and 11.

In the following examples, a resource center in the terminal device may decide the type of resources to be allocated for an APP, and a multi-view APP in the terminal device provides functions such as starting and exiting of the APP in different view modes, including: collecting an App list which may be added to multi-view, saving the latest multi-view layout and a predefined or favorite multi-view layout of a user, managing starting of multi-view or exiting of multi-view, providing a mapping relationship between display sub-regions and resource types to the resource center, and providing a region id of an App to the resource center according to the multi-view layout (for example, the region id is within the range of a maximum number of views which may be supported by a platform; in the presence of a maximum of 2 views, a left-side region id is 1, and a right-side region id is 2; in the presence of a maximum of 4 views, the region ids are 1, 2, 3, and 4, which are natural numbers starting from 1).

### 1. Resource Allocation in Single-View Mode

A resource specified by an App should be allocated, the allocation is not determined by the terminal device, and the resource finally allocated is a main resource or a sub-resource specified by the App. That is, the terminal device is not required to make a decision in a single-view mode. As shown in FIG. 10, a resource allocation process in the single-view mode is as follows.

In operation 10.1, a user opens App1 and views the content of App1.

In operation 10.2, App1 queries a resource option (i.e. a resource type currently allocated thereto) from a resource center with its own application identification number (Appid) and a required resource type (a main resource or a sub-resource).

In operation 10.3, it is currently a single-view mode. By default, in a normal mode (i.e. single-view mode), the resource center does not make a decision but directly assigns the resource type required by App1 to the resource option.

In operation 10.4, the resource center returns the resource option to App1.

Taking a video decoder resource as an example, the resource type specified by App1 may be a main resource, and the returned resource option is the main resource, as shown in the following Table 2:

TABLE 2

| | | Resource type | Returned | Resource |
|---|---|---|---|---|
| | | requested by | resource | obtained |
| View | Resource | App | option | by App |
| Single- | Video | RM_CATEGORY_ | RM_CATEGORY_ | Main |
| view | Decoder | VIDEO_DECODER | VIDEO_DECODER | resource |
| | | (Main resource) | (Main resource) | |

Taking a video decoder resource as an example, the resource type specified by App1 may be a sub-resource, and the returned resource option is the sub-resource, as shown in the following Table 3:

TABLE 3

| | | Resource type | Returned | Resource |
|---|---|---|---|---|
| | | requested by | resource | obtained |
| View | Resource | App | option | by App |
| Single- | Video | RM_CATEGORY_ | RM_CATEGORY_ | Sub- |
| view | Decoder | VIDEO_ | VIDEO_ | resource |
| | | DECODER_SUB | DECODER_SUB | |
| | | (Sub-resource) | (Sub-resource) | |

In operation 10.5, App1 transmits the resource option received in operation 4 to a resource manager of the terminal device so as to perform resource application and obtain a resource specified by App1.

### 2. Resource Allocation in Multi-View Mode

In a multi-view mode, an App is not required to explicitly specify a main resource or a sub-resource when started, but a resource center decides a resource finally allocated to the APP. That is, in a multi-view scenario, the resource center will ignore a resource type specified by the App and self-decide a resource type. FIG. 11 illustrates the following operations for enabling a multi-view mode.

In operation 11.1, a user starts multi-view through a multi-view App, Apps in multi-view being App1 and App2.

In operation 11.2, the multi-view App sets a current resource strategy as a multi-view mode for the resource center, i.e., a multi-view display region allocation strategy is currently adopted.

In operation 11.3, the multi-view App notifies the resource center of respective region ids of App1 and App2.

In operation 11.4, the App queries a resource option from the resource center with app_id and a required resource type.

It should be noted here that, for the convenience of implementation, a resource option query message in the same format as in the single-view mode is adopted. Therefore, the App is also required to send the required resource type to the resource center here. However, this information does not participate in the determination of a resource option in the subsequent operations.

In operation 11.5, the resource center finds a region id of the corresponding App according to app_id, selects a resource type according to the region id and a mapping relationship between display sub-regions and resource types, and determines a resource option.

In operation 11.6, the resource center returns the resource option to the App.

In operation 11.7, the App applies for a resource from a resource manager by using the resource type and the resource option, and is allocated with the resource of the corresponding resource type (main resource or sub-resource).

Further, considering that when the terminal device is required to switch from a single-view mode to a multi-view mode, if an APP in the single-view mode is not executed in the switched multi-view mode, the APP will be closed and corresponding resources occupied thereby will also be released. If an APP originally in the single-view mode will be still executed in the multi-view mode, it is necessary to consider whether the resources occupied thereby are required to be updated. In particular, the APP may use all the resources of the terminal device in the single-view mode, i.e. both a main resource and a sub-resource may be occupied. In this case, when entering the multi-view mode, the sub-resource occupied thereby in the single-view mode is required to be abandoned for use by the APP using the sub-resource in the multi-view mode. Specifically, the aforementioned object may be achieved by using the following operations a1-a3, i.e. the method further includes the following operations.

In operation a1, when the terminal device is required to switch from a single-view mode to a multi-view mode, if a first App in focus in the single-view mode is still required to be executed in the multi-view mode, the terminal device triggers the first App to release a sub-resource occupied thereby.

In operation a2, a resource type corresponding to a display sub-region used by the first APP in the multi-view mode is determined according to a preset mapping relationship between display sub-regions and resource types. If the first APP corresponds to different resource types before and after the switching, the first APP is triggered to release a main resource occupied thereby and a corresponding resource is acquired on the basis of the resource type corresponding to the display sub-region.

The display sub-region is obtained according to a preset multi-view display region allocation strategy and on the basis of an occupation condition of a display region when the first APP is started. In this way, it may be ensured that the resource type corresponding to the display sub-region used by the first APP in the multi-view mode is not the same as resource types of other APPs, and thus resource conflicts in the multi-view mode may be avoided.

Here, if the first APP corresponds to different resource types before and after the switching, it means that resources of the first APP are required to be exchanged, i.e. to change from a main resource to a sub-resource. Therefore, at this moment, the first APP is required to be triggered to release the main resource occupied thereby and a corresponding resource is acquired on the basis of the resource type corresponding to the display sub-region.

In operation a3, if a maximum resolution supported by the resource type corresponding to the first App in the multi-view mode is less than a maximum resolution supported by a resource type corresponding to the first App in the single-view mode, the first APP is triggered to update an allowable maximum resolution thereof to the maximum resolution supported by the resource type corresponding thereto in the multi-view mode, and a playing content in the multi-view mode is adjusted and controlled on the basis of the allowable maximum resolution.

In this operation, considering that the maximum resolution supported by the resource type of the first App when switching from the single-view mode to the multi-view mode may be reduced, the playing content in the multi-view mode is required to be adjusted and controlled at this moment, whereby the multimedia content may be played normally.

Here, if the maximum resolution supported by the resource type corresponding to the first App in the multi-view mode is less than the maximum resolution supported by the resource type corresponding to the first App in the single-view mode, it means that the maximum resolution supported by the resource type used by the first App when entering the multi-view mode is reduced.

The maximum resolution supported by the resource type corresponding to the aforementioned first App in the multi-view mode is less than the maximum resolution supported by the resource type corresponding thereto in the single-view mode. This generally shows the following two cases in practical applications.

In the first case, the maximum resolution supported by the corresponding resource type of the first App in the multi-view mode is less than a maximum resolution supported by a display panel of the terminal device.

In the second case, a preset multi-view mode resource resolution of the first App is required to be FHD/FHD+. FHD represents a resource required to support an FHD resolution, and the App may limit the resolution of the content thereof to FHD. FHD+ represents a resource required to support at least the FHD resolution, and FHD or UHD resources may be allocated to the App according to different cases. If FHD resources are allocated, the App may limit the resolution of the content thereof to FHD.

In an implementation, the playing content in the multi-view mode may be adjusted and controlled in the aforementioned operation a3 by specifically using the following method:

The first APP determines whether the resolution of a current playing content exceeds the allowable maximum resolution, and if yes, the current playing content is adjusted to a playing content with a first resolution and/or a user is notified that the resolution of the current playing content is not supported. The first resolution is less than or equal to the allowable maximum resolution.

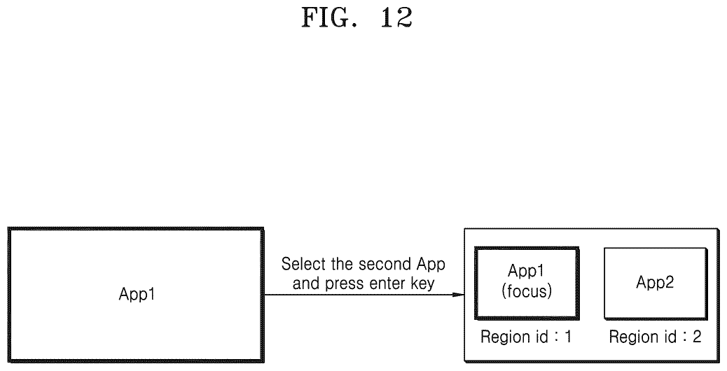

The specific implementation of the aforementioned operations a1-a3 is described in detail below through two specific examples with reference to FIGS. 12-14.

In the following examples, a resource center in the terminal device may decide the type of resources to be allocated for an APP, and a multi-view APP in the terminal device provides functions such as starting and exiting of the APP in different view modes, including: collecting an App list which may be added to multi-view, saving the latest multi-view layout and a predefined or favorite multi-view layout of a user, managing starting of multi-view or exiting of multi-view, providing a mapping relationship between display sub-regions and resource types to the resource center, and providing a region id of an App to the resource center according to the multi-view layout.

1. Situation where Resources are not Required to be Re-Allocated for APPs Already Executed after APPs Enter Multi-View:

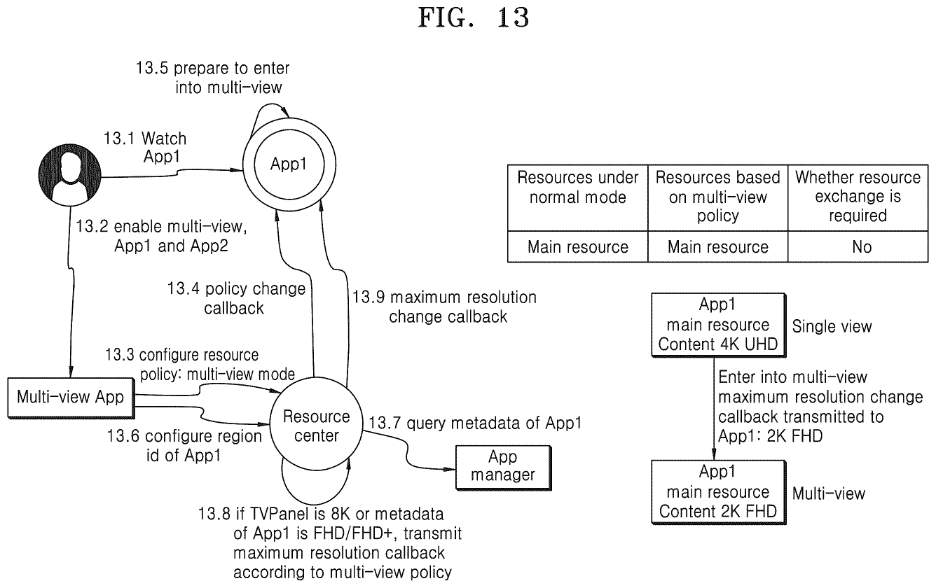

As shown in FIG. 12, when App2 is started to enter a multi-view mode in a scenario where App1 is executed, App1 will still be in focus. In this case, resources are not required to be re-allocated for App1 already executed. As shown in FIG. 13, the specific processing flow includes the following operations.

In operation 13,1, in a single-view mode, a user is watching App1 in full screen, a main resource is used, and a maximum resolution of a playing content of App1 may reach a maximum resolution supported by a panel. The resolution of the playing content in a 4K television may be up to 4K, and the resolution of the playing content in an 8K television may be up to 8K.

In operation 13.2, a user starts multi-view through a multi-view App, Apps in multi-view being App1 and App2.

In operation 13.3, the multi-view App sets a current resource strategy as a multi-view mode for a resource center.

In operation 13.4, the resource center notifies App1 of the change of a resource strategy to the multi-view mode by callback.

In operation 13.5, after receiving the notification, App1 makes some preparations to enter multi-view, including: prohibiting some functions of using a sub-resource, such as Picture-in-Picture (PIP), so as to release the sub-resource occupied thereby, wherein the sub-resource will be used by an App newly added into multi-view.

In operation 13.6, the multi-view App sets a region ID of App1 for the resource center.

In operation 13.7, the resource center queries a metadata item multi-view_min_resource of App1. The metadata item is used to characterize minimum resource requirements of App1.

In operation 13.8, if the panel has a resolution of 8K (the 8K content can no longer be played under multi-view), or the metadata item multi-view_min_resource of App1 is FHD/FHD+, an allowable maximum resolution of a resource type corresponding to the region id of App1 is obtained according to the region id of App1 and a mapping relationship between display sub-regions and resource types, and then an allowable maximum resolution of App1 under multi-view is obtained.

In operation 13.9, the resource center sends a message that the allowable maximum resolution changes to App1, and App1 determines whether to change a current playing content according to the resolution of the playing content, or prompts the user that “the current content is not supported”.

2. Situation where Resources are Required to be Re-Allocated for APPs Already Executed after APPs Enter Multi-View:

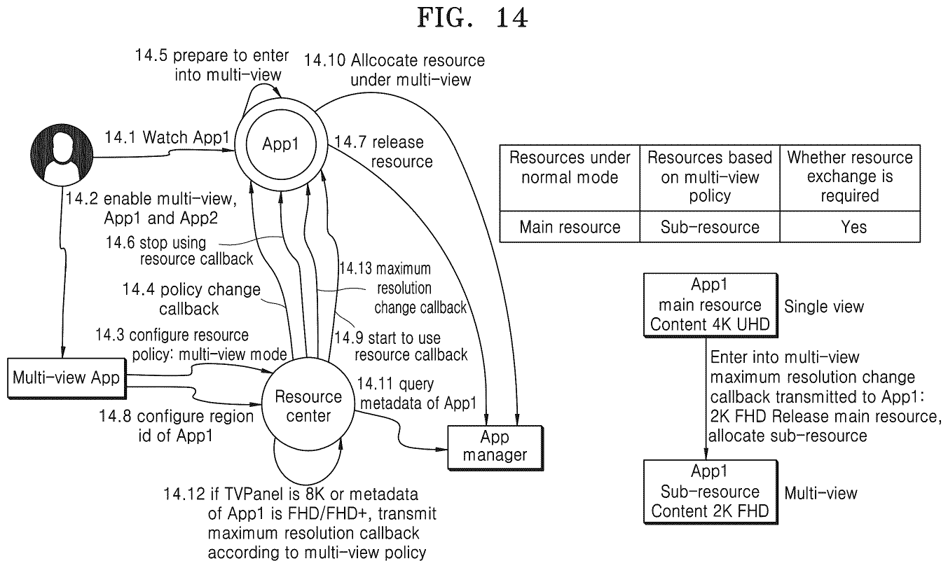

As shown in FIG. 14, a specific implementation example in this scenario includes the following operations.

In operation 14.1, in a single-view mode, a user is watching App1 in full screen, a main resource is used, and a maximum resolution of a playing content of App1 may reach a maximum resolution supported by a panel. The resolution of the playing content in a 4K television may be up to 4K, and the resolution of the playing content in an 8K television may be up to 8K.

In operation 14.2, a user starts multi-view through a multi-view App, Apps in multi-view being App1 and App2.

In operation 14.3, the multi-view App sets a resource strategy as a multi-view mode for a resource center.

In operation 14.4, the resource center notifies App1 of the change of a resource strategy to the multi-view mode by callback.

In operation 14.5, after receiving the notification, App1 makes some preparations to enter multi-view, including: prohibiting some functions of using a sub-resource, such as PIP, wherein the sub-resource will be used by an App newly added into multi-view.

In operation 14.6, the resource center decides that resources are required to be exchanged according to a region and resource bind strategy of a platform, and sends a callback of stopping using resources to App1.

In operation 14.7, after receiving the callback of stopping using resources, App1 releases a main resource occupied.

In operation 14.8, the multi-view App sets a region ID of App1 for the resource center.

In operation 14.9, the resource center sends a callback of starting to use resources to App1.

In operation 14.10, App1 applies for a corresponding sub-resource in a multi-view scenario.

In operation 14.11, the resource center queries a metadata item multi-view_min_resource of App1.

In operation 14.12, if the panel has a resolution of 8K (the 8K content can no longer be played under multi-view), or the metadata item multi-view_min_resource of App1 is FHD/FHD+, an allowable maximum resolution of App1 under multi-view is obtained according to the region ID of App1 and a multi-view strategy.

In operation 14.13, a callback that the allowable maximum resolution changes is sent to App1, and App1 determines whether to change a current playing content according to the resolution of the playing content, or prompts the user that “the current content is not supported”.

Further, it is considered that when the terminal device switches from a multi-view mode to a single-view mode, the allowable maximum resolution thereof may be increased due to the change of resources. In this case, in order to fully utilize resources currently allocated for the APP to obtain a better multimedia playing effect, a playing content in the single-view mode may be further adjusted in time by using the following operations b1-b3.

In operation b1, when the terminal device switches from a multi-view mode to a single-view mode, if a second APP in focus after the switching uses a sub-resource in the multi-view mode, the second APP is triggered to release the sub-resource and to acquire a main resource in the single-view mode.

In operation b2, the second APP is triggered to update a currently allowable maximum resolution to a maximum resolution supported when using the main resource in the single-view mode.

In operation b3, the second APP adjusts and controls a playing content in the single-view mode on the basis of the allowable maximum resolution.

In an implementation, the playing content in the single-view mode may be adjusted and controlled in operation b3 by using the following method.

The second APP determines whether the resolution of a current playing content is less than the allowable maximum resolution, and if yes, the current playing content is adjusted to a playing content with a second resolution and/or a user is notified that a playing content with a higher resolution is currently supported. The second resolution is greater than the resolution of the current playing content and less than or equal to the allowable maximum resolution.

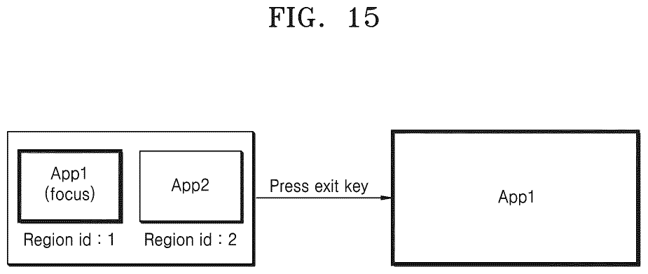

The specific implementation of the aforementioned operations b1-b3 is described in detail below through two specific examples with reference to FIGS. 15-17.

In the following examples, a resource center in the terminal device may decide the type of resources to be allocated for an APP, and a multi-view APP in the terminal device provides functions such as starting and exiting of the APP in different view modes, including: collecting an App list which may be added to multi-view, saving the latest multi-view layout and a predefined or favorite multi-view layout of a user, managing starting of multi-view or exiting of multi-view, providing a mapping relationship between display sub-regions and resource types to the resource center, and providing a region id of an App to the resource center according to the multi-view layout.

1. Situation where Resources are not Required to be Re-Allocated after Exiting Multi-View:

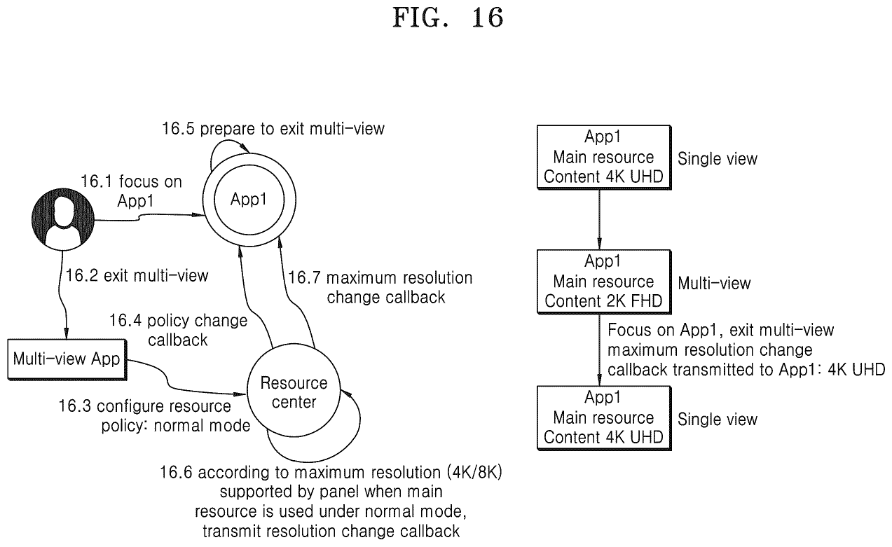

As shown in FIG. 15, when App2 is closed in a multi-view mode to enter a single-view mode, App1 will still be in focus. In this case, resources are not required to be re-allocated for App1. As shown in FIG. 16, the specific implementation process of operations b1-b3 includes the following operations.

In operation 16.1, App1 uses a main resource in a multi-view mode, and the user focuses on App1.

In operation 16.2, the user exits multi-view through a multi-view App, and after exiting multi-view, App1 becomes a full-screen App.

In operation 16.3, the multi-view App sets a resource strategy as a normal mode (i.e. single-view mode) for a resource center.

In operation 16.4, the resource center notifies App1 of the change of the resource strategy to the normal mode by callback.

In operation 16.5, App1 is ready to exit multi-view upon receipt of the notification.

In operation 16.6, a resolution change callback (i.e. resolution change feedback) is sent according to a maximum resolution (4K/8K) supported by a panel when using the main resource in the normal mode.

In operation 16.7, the resource center sends a message that an allowable maximum resolution is changed to App1, and APP1 adjusts and controls a playing content in the single-view mode on the basis of the allowable maximum resolution. Thus, the limited content playing in App1 in a multi-view scenario is no longer limited after exiting multi-view.

2. Situation where Resources are Required to be Re-Allocated after Exiting Multi-View:

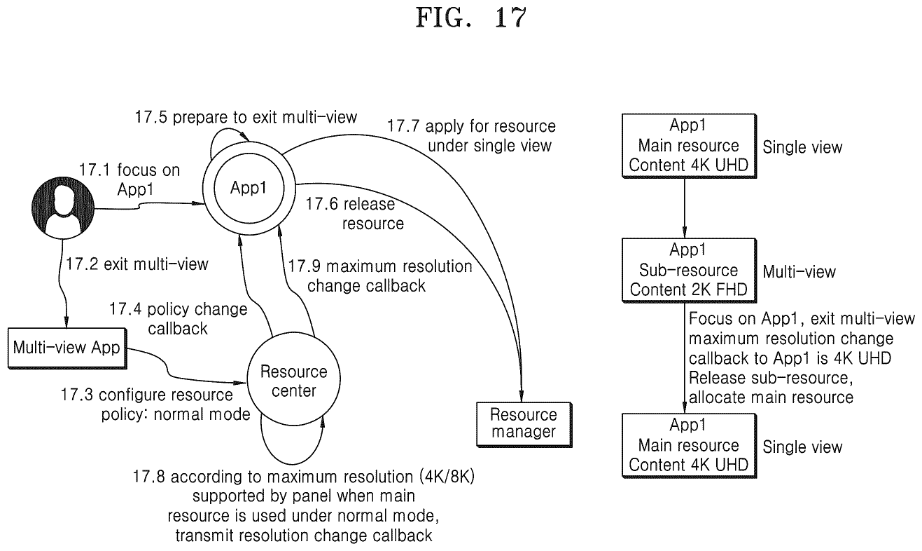

When the terminal device switches from a multi-view mode to a single-view mode, if the APP in focus after the mode switching uses a sub-resource before the switching, resources are required to be exchanged, i.e. switched from a sub-resource to a main resource. As shown in FIG. 17, in an example, operations b1-b3 may be implemented by specifically using the following process.

In operation 17.1, App1 uses a sub-resource in a multi-view mode, and the user focuses on App1.

In operation 17.2, the user exits multi-view through a multi-view App, and after exiting multi-view, an App in full screen is App1.

In operation 17.3, the multi-view App sets a resource strategy as a normal mode for a resource center.

In operation 17.4, the resource center notifies App1 of the change of the resource strategy to the normal mode by callback.

In operation 17.5, App1 is ready to exit multi-view upon receipt of the notification.

In operation 17.6, App1 knows that the sub-resource is currently used thereby, a main resource will be used after exiting multi-view, and therefore, the sub-resource is released.

In operation 17.7, a resource is re-applied for under single-view, and the resource obtained by application at this moment is the main resource.

In operation 17.8, a resolution change callback is sent according to a maximum resolution (4K/8K) supported by a panel when using the main resource in the normal mode.

In operation 17.9, a callback that an allowable maximum resolution is changed is sent to App1, and the limited content playing in App1 in a multi-view scenario is no longer limited after exiting multi-view.

In an implementation, in order to optimize user experience, the terminal device may provide a multi-view APP, and a user uses a user interface of the multi-view APP to start and close APPs in different view modes. This may be implemented by specifically using the following method.

The terminal device receives an APP starting instruction from a user via a multi-view APP in a single-view mode, starts a corresponding APP according to the APP starting instruction, and enters a multi-view mode. A user interface of the multi-view APP provides, for each display sub-region, an APP set capable of currently using the display sub-region, whereby the user selects to start using the APP of the display sub-region on the basis of the APP set, and the APP set is obtained according to a preset multi-view display region allocation strategy and on the basis of an occupation condition of a current display region and an installed APP in the terminal device.

In the aforementioned method, an APP set of each display sub-region is required to be obtained according to a preset multi-view display region allocation strategy. In this way, APPs executed in each display sub-region may be controlled to avoid resource conflicts by using the APP set of each display sub-region.

As can be seen from the aforementioned method embodiment, according to the aforementioned multi-view resource allocation method, when a multimedia APP is started, a terminal device determines the type of resources which may be applied for by the multimedia APP on the basis of a current view mode. In this way, the resources allocated for the multimedia APP may be matched with an actual application scenario, thereby avoiding the problem of resource allocation conflicts in a multi-view scenario.

In addition, according to the aforementioned method embodiment, an APP is not required to determine the type of resources used thereby, so that an APP developer is not required to realize the function of determining the resource type when developing the APP, thereby reducing the development burden of the APP developer and making it easy to add the App into multi-view. Moreover, the terminal device decides the resource type independently of the APP, whereby the expansibility and flexibility of a multi-view function are also effectively improved, thereby being beneficial to add more APPs into multi-view and enriching the multi-view application scenario.

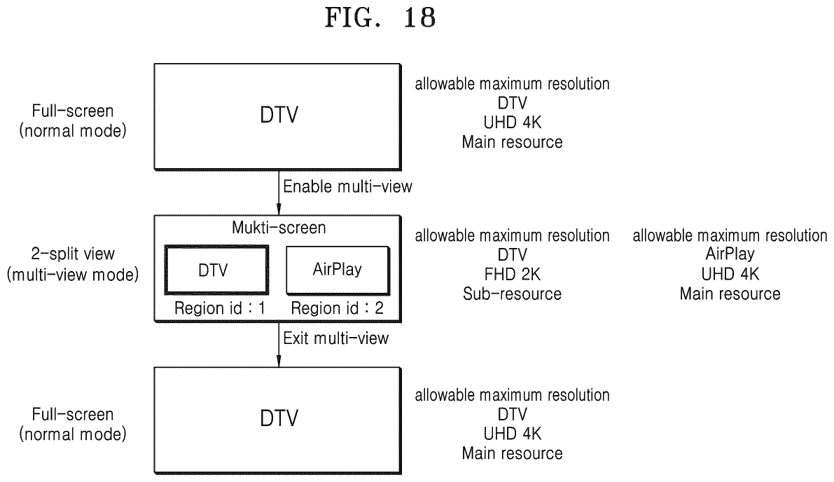

Specific implementations of the aforementioned method embodiment are described in detail below with reference to FIGS. 18-22 through several application examples in specific scenarios.

### Scenario 1:

### Scenario Description:

### Terminal Device A

Single-view:
   Main resource: UHD 4K
Multi-view:
   Number of resources: 2 display sub-regions, 2K+4K (sub+main)
   Main resource: UHD 4K
   Sub-resource: FHD 2K

### App1: Digital TV (DTV)

Addable in multi-view
Minimum resource requirement: FHD

### App2: AirPlay

Addable in multi-view
Minimum resource requirement: UHD

As shown in FIG. 18, the specific implementation process of the aforementioned method embodiment includes the following operations.

In operation 1, under single-view, a current full-screen App is DTV, an allowable maximum resolution is UHD 4K, and DTV obtains a main resource by application.

In operation 2, a user connects to a television via iPhone AirPlay to start multi-view.

In operation 3, under multi-view, DTV is placed in a left region with a region id of 1, an allowable maximum resolution is FHD 2K, and a sub-resource is used.

In operation 4, DTV releases the main resource and re-applies for the sub-resource, and DTV resources are exchanged.

In operation 5, the capability of the DTV resources is weakened, and if the content is UHD before entering multi-view, a window showing “the current content is not supported” may be popped to prompt the user, or the content is switched to FHD content to be continuously played.

In operation 6, under multi-view, AirPlay is located in a right region with a region id of 2, an allowable maximum resolution is UHD 4K, and a main resource is used.

In operation 7, AirPlay obtains the main resource by application.

In operation 8, a focus App is DTV before exiting multi-view, the user exits multi-view through a multi-view App, and the full-screen App should be DTV after exiting multi-view.

In operation 9, under single-view, DTV releases the sub-resource and re-applies for the main resource, and DTV resources are exchanged.

In operation 10, the capability of the DTV resources is enhanced, an allowable maximum resolution is UHD 4K, and the limited content playing in DTV in a multi-view scenario is no longer limited after exiting multi-view.

### Scenario 2:

### Scenario Description:

### Terminal Device B

Single-view:
   Main resource: UHD 4K
Multi-view:
   Number of resources: 2 display sub-regions, 4K+2K (main+sub)
   Main resource: UHD 4K
   Sub-resource: FHD 2K

### App1: Youku

Addable in multi-view
Minimum resource requirement: FHD+

### App2: Screen Mirror

Addable in multi-view
Minimum resource requirement: FHD

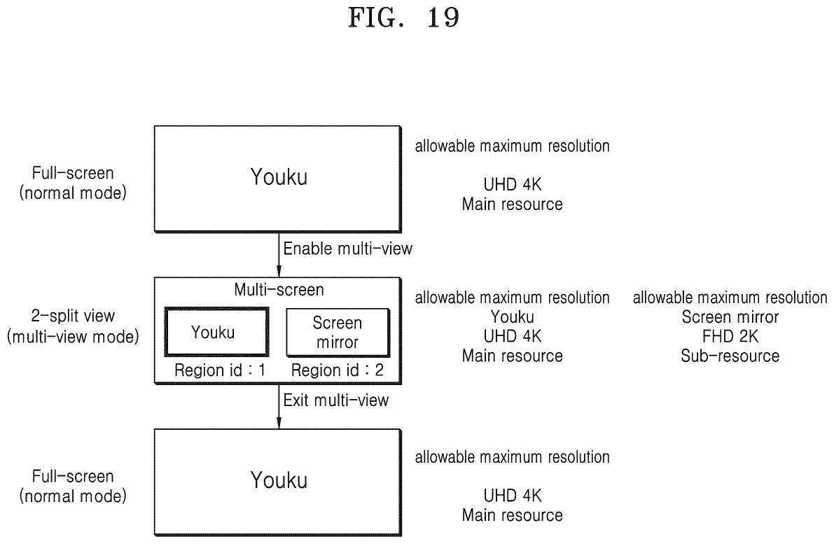

As shown in FIG. 19, the specific implementation process of the aforementioned method embodiment includes the following operations.

In operation 1, under single-view, a current full-screen App is Youku, an allowable maximum resolution is UHD 4K, and Youku obtains a main resource by application.

In operation 2, a user connects to a television via a screen mirror of a mobile phone to start multi-view.

In operation 3, under multi-view, Youku is placed in a left region with a region id of 1, an allowable maximum resolution is UHD 4K, and a main resource is used without change.

In operation 4, under multi-view, the screen mirror is located in a right region with a region id of 2, an allowable maximum resolution is FHD 2K, and a sub-resource is used.

In operation 5, the screen mirror obtains a sub-resource by application.

In operation 6, a focus App is Youku before exiting multi-view, the user exits multi-view through a multi-view App, and the full-screen App is Youku after exiting multi-view.

In operation 7, under single-view, Youku resources are unchanged, the main resource is continuously used, and an allowable maximum resolution is UHD 4K.

### Scenario 3:

### Scenario Description:

### Terminal Device C

Single-view:
   Main resource: UHD 8K
Multi-view:
   Number of resources: 4 display sub-regions, 4*4K (main+sub1+sub2+sub3)
   Main resource/sub-resource 1/sub-resource 2/sub-resource 3: UHD 4K, identical resource capability

### App1: DTV

Addable in multi-view
Minimum resource requirement: FHD

### App2: Youku

Addable in multi-view
Minimum resource requirement: FHD+

### App3: HDMI

Addable in multi-view
Minimum resource requirement: FHD

### App4: AirPlay

Addable in multi-view
Minimum resource requirement: UHD

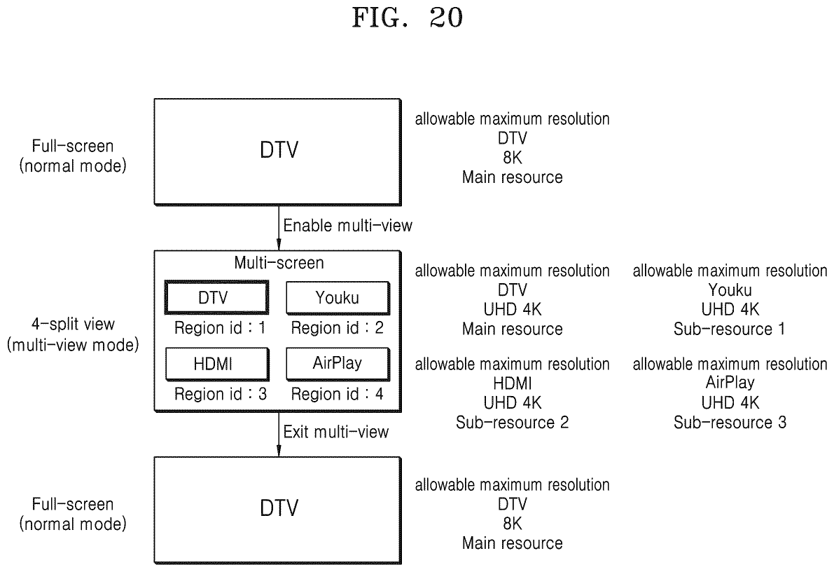

As shown in FIG. 20, the specific implementation process of the aforementioned method embodiment includes the following operations.

In operation 1, under single-view, a current full-screen App is DTV, an allowable maximum resolution is 8K, and DTV obtains a main resource by application.

In operation 2, a user selects Youku to be added into multi-view.

In operation 3, under multi-view, the location of DTV has a region id of 1, an allowable maximum resolution is UHD 4K, and the main resource is used. If the content is 8K before entering multi-view, a window showing “the current content is not supported” may be popped to prompt the user, or the content is switched to UHD 4K content to be continuously played.

In operation 4, under multi-view, the location of Youku has a region id of 2, an allowable maximum resolution is UHD 4K, and sub-resource 1 is used.

In operation 5, Youku obtains sub-resource 1 by application.

In operation 6, the user selects an HDMI external device to be added into multi-view.

In operation 7, under multi-view, the location of HDMI has a region id of 3, an allowable maximum resolution is UHD 4K, and sub-resource 2 is used.

In operation 8, HDMI obtains sub-resource 2 by application.

In operation 9, the user connects to a television via iPhone AirPlay to be added into multi-view.

In operation 10, under multi-view, the location of AirPlay has a region id of 4, an allowable maximum resolution is UHD 4K, and sub-resource 3 is used.

In operation 11, AirPlay obtains sub-resource 3 by application.

In operation 12, a focus App is DTV before exiting multi-view, the user exits multi-view through a multi-view App, and the full-screen App should be DTV after exiting multi-view.

In operation 13, under single-view, DTV resources are unchanged, the main resource is continuously used, an allowable maximum resolution is 8K, and the limited content playing in DTV in a multi-view scenario is no longer limited after exiting multi-view.

### Scenario 4:

### Scenario Description:

### Terminal Device D

Single-view:
   Main resource: UHD 4K
Multi-view:
   Number of resources: 2 display sub-regions, 2K+2K (main+sub)
   Main resource: FHD 2K
   Sub-resource: FHD 2K

### App1: Youku

Addable in multi-view
Minimum resource requirement: FHD+

### App2: Screen Mirror

Addable in multi-view
Minimum resource requirement: FHD

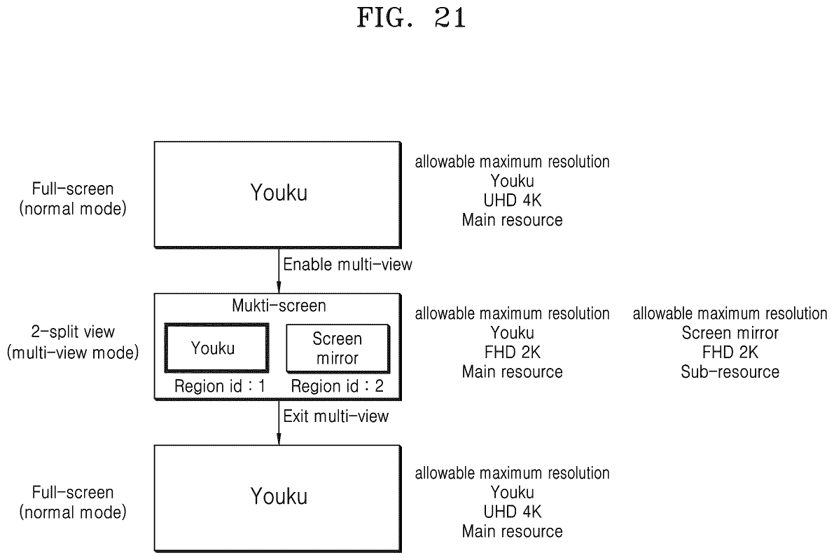

As shown in FIG. 21, the specific implementation process of the aforementioned method embodiment includes the following operations.

In operation 1, under single-view, a current full-screen App is Youku, an allowable maximum resolution is UHD 4K, and Youku obtains a main resource by application.

In operation 2, a user connects to a television via a screen mirror of a mobile phone to start multi-view.

In operation 3, under multi-view, Youku is placed in a left region with a region id of 1, an allowable maximum resolution is FHD 2K, and the main resource is used without change. If the content is UHD 4K before entering multi-view, a window showing “the current content is not supported” may be popped to prompt the user, or the content is switched to FHD 2K content to be continuously played.

In operation 4, under multi-view, the screen mirror is located in a right region with a region id of 2, an allowable maximum resolution is FHD 2K, and a sub-resource is used.

In operation 5, the screen mirror obtains a sub-resource by application.

In operation 6, a focus App is Youku before exiting multi-view, the user exits multi-view through a multi-view App, and the full-screen App should be Youku after exiting multi-view.

In operation 7, under single-view, Youku resources are unchanged, the main resource is used, an allowable maximum resolution is UHD 4K, and the limited content playing in Youku in a multi-view scenario is no longer limited after exiting multi-view.

### Scenario 5:

### Scenario Description:

### Terminal Device E

Single-view:
   Main resource: 8K
Multi-view:
   Number of resources: 2 display sub-regions, 4K+4K (main+sub)
   Main resource: UHD 4K
   Sub-resource: UHD 4K

### App1: Digital TV (DTV)

Addable in multi-view
Minimum resource requirement: FHD

### App2: AirPlay

Addable in multi-view
Minimum resource requirement: UHD

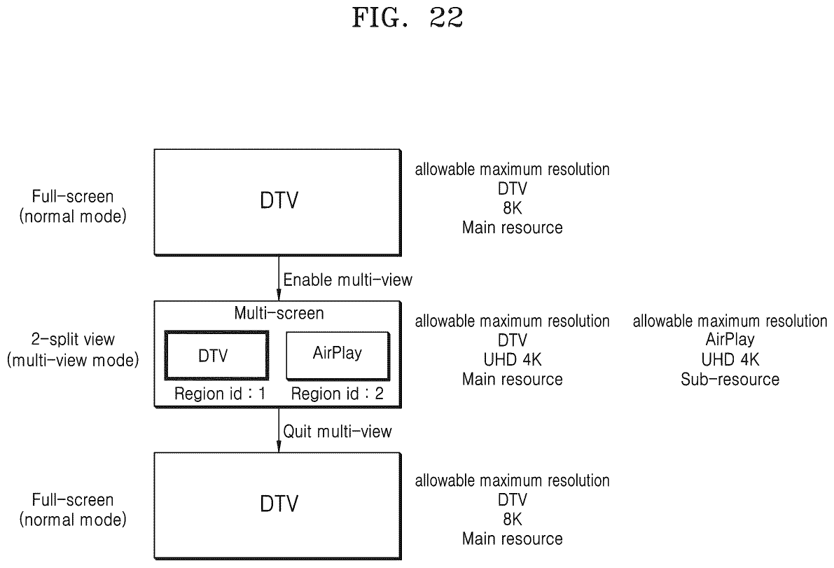

As shown in FIG. 22, the specific implementation process of the aforementioned method embodiment includes the following operations.

In operation 1, under single-view, a current full-screen App is DTV, an allowable maximum resolution is 8K, and DTV obtains a main resource by application.

In operation 2, a user connects to a television via iPhone AirPlay to start multi-view.

In operation 3, under multi-view, DTV is placed in a left region with a region id of 1, an allowable maximum resolution is UHD 4K, and the main resource is used without change. If the content is 8K before entering multi-view, a window showing “the current content is not supported” may be popped to prompt the user, or the content is switched to UHD 4K content to be continuously played.

In operation 4, under multi-view, AirPlay is located in a right region with a region id of 2, an allowable maximum resolution is UHD 4K, and a sub-resource is used.

In operation 5, AirPlay obtains the sub-resource by application.

In operation 6, a focus App is DTV before exiting multi-view, the user exits multi-view through a multi-view App, and the full-screen App should be DTV after exiting multi-view.

In operation 7, under single-view, DTV resources adopt the main resource without change, an allowable maximum resolution is 8K, and the limited content playing in DTV in a multi-view scenario is no longer limited after exiting multi-view.

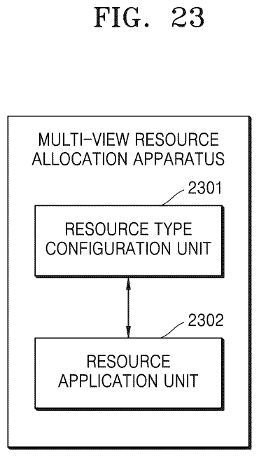

One or more embodiments of the disclosure provides a multi-view resource allocation apparatus on the basis of the aforementioned method embodiment. As shown in FIG. 23, the apparatus includes: a resource type configuration unit 2301 and a resource application unit 2302.

The multi-view resource allocation apparatus shown in FIG. 23 may be implemented in a computing device including at least one processor and memory, such as a desktop or a laptop computer.

A program for performing multi-view resource allocation may be stored in the memory of the computing device. Accordingly, operations described below as being performed by the resource type configuration unit 2301 and the resource application unit 2302 of FIG. 23 can be seen as actually being performed by the processor of the computing device, and the resource type configuration unit 2301 and the resource application unit 2302 of FIG. 23 The resource application unit 2302 can be viewed as a software unit responsible for a specific function or role in the entire program stored in the memory of the computing device.

The resource type configuration unit 2301 is configured to enable, when an APP of a terminal device is started, the terminal device to determine a resource type allocated for the APP on the basis of a current view mode. The view mode is a single-view mode or a multi-view mode, and the resource type is a main resource or a sub-resource.

The resource application unit 2302 is configured to acquire, by the APP, a corresponding resource according to the allocated resource type.

Since the principles of the method and apparatus for solving the problems are similar, the implementations of the apparatus and the method may be referred to each other, and the repetition will be omitted.

Corresponding to the aforementioned method embodiment, one or more embodiments of the present application also provides a multi-view resource allocation device, including a processor and a memory. The memory stores an application executable by the processor for causing the processor to perform the multi-view resource allocation method as described above. Specifically, a system or apparatus with a storage medium may be provided. A software program code that realizes the functions of any one implementation in the above embodiment is stored on the storage medium, and a computer (or a CPU or an MPU) of the system or apparatus is caused to read out and execute the program code stored in the storage medium. In addition, some or all of actual operations may be performed by means of an operating system or the like operating on the computer through instructions based on the program code. The program code read out from the storage medium may also be written into a memory provided in an expansion board inserted into the computer or into a memory provided in an expansion unit connected to the computer. Then, an instruction based on the program code causes a CPU or the like installed on the expansion board or the expansion unit to perform some or all of the actual operations, thereby realizing the functions of any one of the aforementioned multi-view resource allocation method implementations.

The memory may be specifically implemented as various storage media such as an electrically erasable programmable read-only memory (EEPROM), a flash memory, a programmable program read-only memory (PROM), etc. The processor may be implemented to include one or more central processing units or one or more field programmable gate arrays. The field programmable gate arrays are integrated with one or more central processing unit cores. Specifically, the central processing unit or central processing unit core may be implemented as a CPU or an MCU.

One or more embodiments of the present application implements a computer program product, including computer programs/instructions. When executed by a processor, the computer programs/instructions implement the operations of the multi-view resource allocation method as described above.

It should be noted that not all the operations and modules in the above flow charts and structural diagrams are necessary, and some operations or modules may be omitted according to actual requirements. The order of execution of the various operations is not fixed and may be adjusted as required. The division of the various modules is merely to facilitate the description of the functional division adopted. In actual implementation, one module may be implemented by multiple modules. The functions of the multiple modules may also be realized by the same module. These modules may be located in the same device or in different devices.

Hardware modules in the various implementations may be implemented mechanically or electronically. For example, a hardware module may include a specially designed permanent circuit or logic device (e.g. a dedicated processor such as an FPGA or an ASIC) to perform a particular operation. The hardware module may also include a programmable logic device or circuit (e.g. including a general purpose processor or other programmable processors) temporarily configured by software to perform a particular operation. The implementation of the hardware modules mechanically, or using a dedicated permanent circuit, or using a temporarily configured circuit (e.g. configured by software) may be determined based on cost and time considerations.

As used herein, “schematic” means “serving as an instance, example, or illustration”. Any illustration and implementation described herein as “schematic” should not be construed as a more preferred or advantageous technical solution. For simplicity of the drawings, only those portions related to the disclosure are schematically depicted in the figures and are not representative of an actual structure of a product. In addition, for simplicity and ease of understanding, only one of components having the same structure or function is schematically drawn or marked in some figures. As used herein, “one” does not mean to limit the number of portions related to the disclosure to “only one”, and “one” does not mean to exclude the case that the number of portions related to the disclosure is “more than one”. As used herein, “upper”, “lower”, “front”, “back”, “left”, “right”, “inner”, “outer”, and the like are used merely to indicate relative positional relationships between related portions, and do not limit absolute positions of these related portions.

The above description is merely preferred embodiments of the disclosure and is not intended to limit the protection scope of the disclosure. Any modifications, equivalent replacements, improvements, etc. that come within the spirit and principles of the disclosure are intended to be within the protection scope of the disclosure.

What is claimed is:

1. A multi-view resource allocation method, comprising:
based on determining that an application (APP) of a terminal device is started, determining, by the terminal device, a resource type allocated for the APP based on a current view mode that is a single-view mode or a multi-view mode, and the resource type being a main resource type or a sub-resource type; and
acquiring, by the APP, a corresponding resource according to the resource type allocated for the APP.

2. The method according to claim 1, wherein the determining the resource type allocated for the APP comprises:
based on determining that the view mode is the single-view mode, determining the resource type allocated for the APP based on a preset resource type of the APP; and
based on determining that the view mode is the multi-view mode, querying a preset mapping relationship between display sub-regions and resource types based on a display sub-region used by the APP in the multi-view mode, obtaining a resource type corresponding to the display sub-region, and allocating the resource type corresponding to the display sub-region to the APP,
wherein the display sub-region is obtained (i) according to a preset multi-view display region allocation strategy and (ii) based on an occupation condition of a display region upon the APP being started.

3. The method according to claim 1, further comprising:
based on determining that the terminal device is required to switch from the single-view mode to the multi-view mode and determining that a first App in focus in the single-view mode is still executed in the multi-view mode, triggering, by the terminal device, the first App to release a sub-resource occupied thereby;
determining a resource type corresponding to a display sub-region used by the first APP in the multi-view mode according to a preset mapping relationship between display sub-regions and resource types;
based on determining that the first APP corresponds to different resource types before and after the switching, triggering the first APP to release a main resource occupied thereby and acquiring the corresponding resource based on the resource type corresponding to the display sub-region, wherein the display sub-region is obtained according to a preset multi-view display region allocation strategy and based on an occupation condition of a display region upon the first APP being started; and
based on determining that a maximum resolution supported by the resource type corresponding to the first App in the multi-view mode is less than a maximum resolution supported by a resource type corresponding to the first App in the single-view mode, triggering the first APP to update an allowable maximum resolution thereof to the maximum resolution supported by the resource type corresponding thereto in the multi-view mode, and adjusting and controlling a playing content in the multi-view mode based on the allowable maximum resolution.

4. The method according to claim 1, wherein the adjusting and controlling a playing content in the multi-view mode comprises:
determining, by a first APP, whether a resolution of a current playing content exceeds an allowable maximum resolution; and
based on determining that the current playing content exceeds the allowable maximum resolution, adjusting the current playing content to a playing content with a first resolution or notifying a user that the resolution of the current playing content is not supported, the first resolution being less than or equal to the allowable maximum resolution.

5. The method according to claim 1, further comprising:
based on determining that the terminal device switches from the multi-view mode to the single-view mode and determining that a second APP in focus after the switching uses a sub-resource in the multi-view mode, triggering the second APP to release the sub-resource and to acquire a main resource in the single-view mode;
triggering the second APP to update a currently allowable maximum resolution to a maximum resolution supported based on determining that the main resource is used in the single-view mode; and
adjusting and controlling, by the second APP, a playing content in the single-view mode based on an allowable maximum resolution.

6. The method according to claim 1, wherein the adjusting and controlling a playing content in the single-view mode comprises:
determining, by a second APP, whether a resolution of a current playing content is less than an allowable maximum resolution; and
based on determining that the resolution of the current playing content is less than the allowable maximum resolution, adjusting the current playing content to a playing content with a second resolution or notifying a user that a playing content with a higher resolution is currently supported, the second resolution being greater than the resolution of the current playing content and less than or equal to the allowable maximum resolution.

7. The method according to claim 1, further comprising:
receiving, by the terminal device, an APP starting instruction from a user via a multi-view APP in the single-view mode, starting a corresponding APP according to the APP starting instruction, and entering the multi-view mode, wherein a user interface of the multi-view APP provides, for each display sub-region, an APP set capable of currently using the display sub-region, whereby the user selects to start using the APP of the display sub-region based on the APP set, and the APP set is obtained (i) according to a preset multi-view display region allocation strategy and (ii) based on an occupation condition of a current display region and an installed APP in the terminal device.

8. A computing device, comprising:
a memory storing a program for allocating multi-view resources; and
at least one processor,
wherein the at least one processor is configured to execute the program to:
enable, based on determining that an application (APP) of a terminal device is started, the terminal device to determine a resource type allocated for the APP based on a current view mode that is a single-view mode or a multi-view mode, and the resource type being a main resource type or a sub-resource type, and
acquire, by the APP, a corresponding resource according to the resource type allocated for the APP.

9. The computing device of claim 8, wherein, while enabling the terminal device to determine the resource type allocated for the APP, the at least one processor is further configured to:
based on determining that the view mode is the single-view mode, enable the terminal device to determine the resource type allocated for the APP based on a preset resource type of the APP, and
based on determining that the view mode is the multi-view mode, enable the terminal device to query a preset mapping relationship between display sub-regions and resource types based on a display sub-region used by the APP in the multi-view mode, obtain a resource type corresponding to the display sub-region, and allocate the resource type corresponding to the display sub-region to the APP, wherein the display sub-region is obtained (i) according to a preset multi-view display region allocation strategy and (ii) based on an occupation condition of a display region when the APP is started.

10. The computing device claim 8, the at least one processor is further configured to:
based on determining that the terminal device is required to switch from the single-view mode to the multi-view mode and based on determining that a first App in focus in the single-view mode is still executed in the multi-view mode, enable the terminal device to trigger the first App to release a sub-resource occupied thereby,
determine a resource type corresponding to a display sub-region used by the first APP in the multi-view mode according to a preset mapping relationship between display sub-regions and resource types,
based on determining that the first APP corresponds to different resource types before and after the switching, trigger the first APP to release a main resource occupied thereby and acquire the corresponding resource based on the resource type corresponding to the display sub-region, wherein the display sub-region is obtained according to a preset multi-view display region allocation strategy and based on an occupation condition of a display region upon the first APP being started, and
based on determining that a maximum resolution supported by the resource type corresponding to the first App in the multi-view mode is less than a maximum resolution supported by a resource type corresponding to the first App in the single-view mode, trigger the first APP to update an allowable maximum resolution thereof to the maximum resolution supported by the resource type corresponding thereto in the multi-view mode, and adjust and control a playing content in the multi-view mode based on the allowable maximum resolution.

11. The computing device of claim 8, wherein, while adjusting and controlling a playing content in the multi-view mode, the at least one processor is further configured to:
determine, by a first APP, whether a resolution of a current playing content exceeds an allowable maximum resolution, and
based on determining that the current playing content exceeds the allowable maximum resolution, adjust the current playing content to a playing content with a first resolution or notify a user that the resolution of the current playing content is not supported, the first resolution being less than or equal to the allowable maximum resolution.

12. The computing device of claim 8, the at least one processor is further configured to:
based on determining that the terminal device switches from the multi-view mode to the single-view mode and based on determining that a second APP in focus after the switching uses a sub-resource in the multi-view mode, trigger the second APP to release the sub-resource and to acquire a main resource in the single-view mode;
trigger the second APP to update a currently allowable maximum resolution to a maximum resolution supported based on determining that the main resource is used in the single-view mode; and
adjust and control, by the second APP, a playing content in the single-view mode based on an allowable maximum resolution.

13. The computing device of claim 8, wherein, while adjusting and controlling a playing content in the single-view mode, the at least one processor is further configured to:
determine, by a second APP, whether a resolution of a current playing content is less than an allowable maximum resolution, and
based on determining that that the resolution of the current playing content is less than the allowable maximum resolution, adjust the current playing content to a playing content with a second resolution or notify a user that a playing content with a higher resolution is currently supported, the second resolution being greater than the resolution of the current playing content and less than or equal to the allowable maximum resolution.

14. The computing device of claim 8, the at least one processor is further configured to:
enable the terminal device to receive an APP starting instruction from a user via a multi-view APP in the single-view mode, start a corresponding APP according to the APP starting instruction, and enter the multi-view mode, wherein a user interface of the multi-view APP provides, for each display sub-region, an APP set capable of currently using the display sub-region, whereby the user selects to start using the APP of the display sub-region based on the APP set, and the APP set is obtained (i) according to a preset multi-view display region allocation strategy and (ii) based on an occupation condition of a current display region and an installed APP in the terminal device.

15. A non-transitory computer readable medium having instructions stored therein, which when executed by a processor cause the processor to execute a method for performing multi-view resource allocation, the method comprising:
based on determining that an application (APP) of a terminal device is started, determining, by the terminal device, a resource type allocated for the APP based on a current view mode that is a single-view mode or a multi-view mode, and the resource type being a main resource type or a sub-resource type; and
acquiring, by the APP, a corresponding resource according to the resource type allocated for the APP.
